(19) United States
(12) Patent Application Publication
(10) Pub. No.: US 2025/0333165 A1
(43) Pub. Date: Oct. 30, 2025

(54) CONTROL DEVICE, CONTROL METHOD, AND STORAGE MEDIUM

(71) Applicant: Japan Aerospace Exploration Agency, Chofu-shi, Tokyo (JP)

(72) Inventors: Daichi WADA, Chofu-shi (JP); Atsushi OSEDO, Chofu-shi (JP); Shinsaku HISADA, Chofu-shi (JP)

(21) Appl. No.: 18/866,996

(22) PCT Filed: Apr. 21, 2023
(86) PCT No.: PCT/JP2023/015888

§ 371 Date: Nov. 18, 2024

(30) Foreign Application Priority Data
May 30, 2022 (JP) 2022-087778

(51) Int. Cl. B64C 39/02; B64C 3/38; B64C 13/18

(52) U.S. Cl. CPC B64C 39/026; B64C 3/38; B64C 13/18

(57) ABSTRACT

According to an embodiment, a control device controls a user-wearable flight device and includes a processing unit configured to acquire state data related to a state of the flight device and manipulation data related to a manipulation of the flight device, input the acquired state data and the acquired manipulation data to a model trained using deep reinforcement learning, and control the flight device on the basis of an output result of the model to which the state data and the manipulation data are input.

### TECHNICAL FIELD

The present invention relates to a control device, a control method, and a program.

Priority is claimed on Japanese Patent Application No. 2022-087778, filed May 30, 2022, the content of which is incorporated herein by reference.

### BACKGROUND ART

A wearable flight device (a flight device) for allowing a user to fly using a thrust force of a jet or rocket is known. This flight device is also referred to as a portable personal air mobility system. On the other hand, technology for controlling a robot using deep reinforcement learning is known (see, for example, Non-Patent Document 1).

### CITATION LIST

### Non-Patent Document

Non-Patent Document 1: X. B. Peng, M. Andrychowicz, W. Zaremba, and P. Abbeel, “Sim-to-real transfer of robotic control with dynamics randomization,” in 2018 IEEE International Conference on Robotics and Automation (ICRA), 2018, pp. 3803-3810.

### SUMMARY OF INVENTION

### Technical Problem

The flight device may not be a large device such as a helicopter, and may be a device such as a suit relatively significantly affected by a human physique difference because each human has a different physique. In this case, it is necessary to adjust the control method of the flight device in accordance with the user wearing the flight device. However, it is difficult to sufficiently adjust the control method of the flight device in accordance with the user in conventional technology. Moreover, it is necessary to readjust the control method every time a user changes, resulting in significant time or economic costs.

The present invention has been made in consideration of such circumstances and an objective of the present invention is to provide a control device, a control method, and a program for enabling a flight device to be appropriately controlled regardless of a user.

### Solution to Problem

An aspect of the present invention is a control device for controlling a user-wearable flight device. The flight device includes a processing unit configured to acquire state data related to a state of the flight device and manipulation data related to a manipulation of the flight device, input the acquired state data and the acquired manipulation data to a model trained using deep reinforcement learning, and control the flight device on the basis of an output result of the model to which the state data and the manipulation data are input.

### Advantageous Effects of Invention

According to an aspect of the present invention, a flight device can be suitably controlled regardless of a user's physique or regardless of the presence or absence of the user.

### BRIEF DESCRIPTION OF DRAWINGS

FIG. 1 An explanatory diagram showing a usage scene of a flight device according to an embodiment.

FIG. 2 A view showing an example of a configuration of the flight device according to the embodiment.

FIG. 3 A diagram showing an example of a configuration of a control device according to the embodiment.

FIG. 4 A flowchart showing a flow of a series of processing steps of a processing unit.

FIG. 5 A diagram showing an example of a deep reinforcement learning model.

### DESCRIPTION OF EMBODIMENTS

Hereinafter, embodiments of a control device, a control method, and a program of the present invention will be described with reference to the drawings.

### Usage Scene of Flight Device

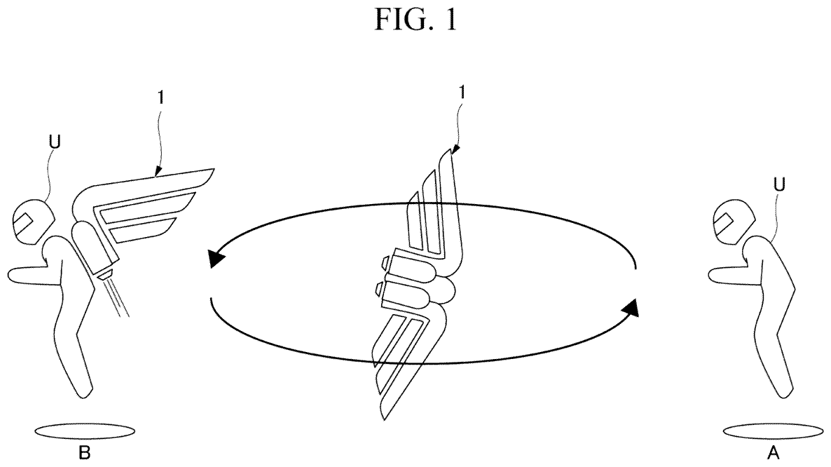

FIG. 1 is an explanatory diagram showing a usage scene of the flight device 1 according to the embodiment. As shown in FIG. 1, the flight device 1 is worn by a user U. The flight device 1 worn by the user U flies under the control of the user U or flies autonomously like an autopilot. For example, the flight device 1 is used to move from a departure point A to a destination B. If the user U wearing the flight device 1 moves from a departure point A to a destination B and then detaches the flight device 1 and lands at the destination B, the flight device 1 may continue to hover around the destination B until the user U wears the flight device 1 again or may return from the destination B to the departure point A according to autonomous flight. The flight device 1 may be used not only by a predetermined single user but also by an unspecified number of users.

For example, the flight device 1 may be used by a mountain rescue team to fly from a headquarters base (a departure point A) installed at the foot of the mountain to a rescue site (a destination B) within the mountain trail. At this time, after a first rescue team member arrives at the destination B, the flight device 1 is detached and lands at the destination B. Subsequently, the flight device 1 independently returns to the departure point A and a second rescue team member wears the flight device 1 and heads to the rescue site. By iterating this process, a plurality of rescue team members can be dispatched to destination B by one flight device 1. Moreover, when the rescue team member has arrived at the destination B, the flight device 1 is detached and lands at the destination B. Subsequently, the flight device 1 may independently head to the departure point A or a refueling point C and independently return to the destination B after a refueling process is completed at the departure point A or the refueling point C. In this case, even if only enough fuel for a one-way trip from the departure point A to the destination B is loaded and manned flight is possible only on an outward route, the manned return flight from the destination B to the departure point A is also possible by refueling with the flight device 1 alone along the way. In this way, a cruising range can also be extended.

Moreover, in addition to the above-described application, the flight device 1 may be used to transfer a person in need of rescue on the ground to a helicopter waiting in the air. Furthermore, the flight device 1 is not limited to the ground and may be used at sea. For example, the flight device 1 may be used to transfer a person in distress at sea to a helicopter in the sky or a ship at sea.

### Configuration of Flight Device

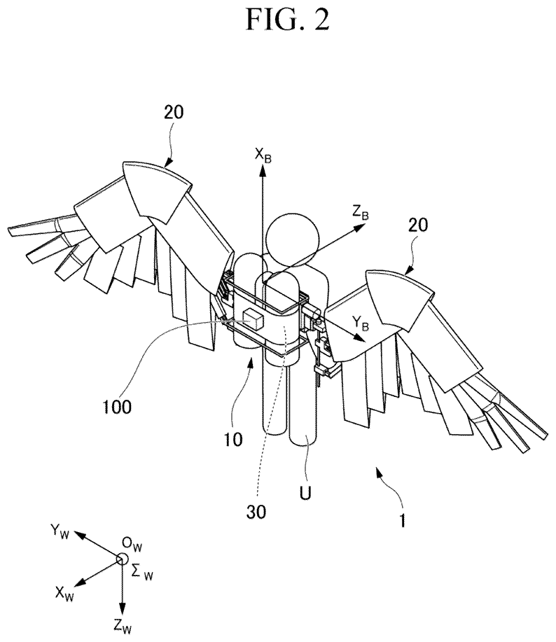

FIG. 2 is a view showing an example of a configuration of the flight device 1 according to the embodiment. As shown in FIG. 2, the flight device 1 includes, for example, a thrust device 10, wings 20, a detachable unit 30, and a control device 100.

Σ_{W} shown in FIG. 2 denotes one Earth-fixed coordinate Σ_{W} of an inertial coordinate system, O_{W} denotes the origin of the Earth-fixed coordinate Σ_{W}, an X_{W} axis represents the true north, a Y_{W} axis represents the east, and a Z_{W} axis represents a vertical downward direction. Moreover, when an inertial principal axis coordinate system is defined as a fixed coordinate system of a flight device body, the X_{B} axis in FIG. 2 is the inertial principal axis of the flight device body when the center of gravity of the flight device 1 is taken as the origin, the Z_{B} axis represents a downward direction of the flight device body, and the Y_{B} axis represents a right direction in a movement direction of the flight device body. In other words, the X_{B} axis is a roll axis, the Z_{B} axis is a yaw axis, and the Y_{B} axis is a pitch axis.

The thrust device 10 causes the flight device 1 to generate a thrust force using fuel 11. For the thrust device 10, for example, a known jet engine may be suitably used. Hereinafter, an example in which a jet engine capable of thrust vectoring is applied to the thrust device 10 will be described. A thrust vectoring mechanism for switching the direction of the jet flow generated by a duct fan (for example, a thrust vectoring mechanism having a paddle, a nozzle, a ring, or the like) is provided on an injection port of the jet engine, and these thrust vectoring mechanisms are controlled by the control device 100.

The wing 20 maintains the attitude of the flight device 1 and changes the flight direction. The direction of the wing 20 may be changed by the user U manipulating a user interface 120 to be described below, may be changed by the control device 100, or may be changed by the user U and the control device 100 in cooperation.

In the present embodiment, the wing 20 includes a link mechanism and can be folded like a bird feather. The wingspan is assumed to be in a state in which the wings 20 are spread. Because the wings 20 can be folded, the wings 20 have the following functions. That is, during high-speed flight, air resistance is reduced by folding the wings 20 and making the wings 20 smaller, and aerodynamic power is obtained by greatly expanding the wings 20 during low-speed flight and takeoff/landing. Moreover, when the flight device 1 is not in use, the wings 20 may be folded to contribute to mobility during transportation. Moreover, the present invention is not limited to the above and the wings 20 may have a structure that allows the wings 20 to be deployed and stored by having an extendable structure in place of folding. Alternatively, the wings 20 may be flat (i.e., fixed wings) without a foldable structure. Moreover, the wings 20 according to the present embodiment includes various actuators in addition to the above-described link mechanism, and can rotate around the roll axis X_{B}, the yaw axis Z_{B}, and the pitch axis Y_{B} shown in FIG. 2. Details will be described below.

In addition, the flight device 1 may be a wingsuit with a cloth stretched between the hands and feet without the wings 20 or may have the fixed wings as described above.

The detachable unit 30 is a member for allowing the user U to wear the flight device 1 and this member has a structure in which the flight device 1 can be easily attached to and detached from the user U. For example, the detachable unit 30 may have a structure including a structure configured to be hung on the shoulders like a general rucksack and a fastener for fixing the flight device 1 to the user U. Alternatively, in a state in which each user U wears a mounting member having a shape corresponding to the detachable unit 30 in advance, a structure in which the user U and the detachable unit 30 are appropriately fixed via the mounting member worn by the user U may be adopted.

The control device 100 controls a thrust force of the thrust device 10 or controls a thrust direction. Furthermore, the control device 100 adjusts an attitude of the flight device 1 or changes a flight direction by controlling a shape and direction of the wings 20.

### Configuration of Control Device

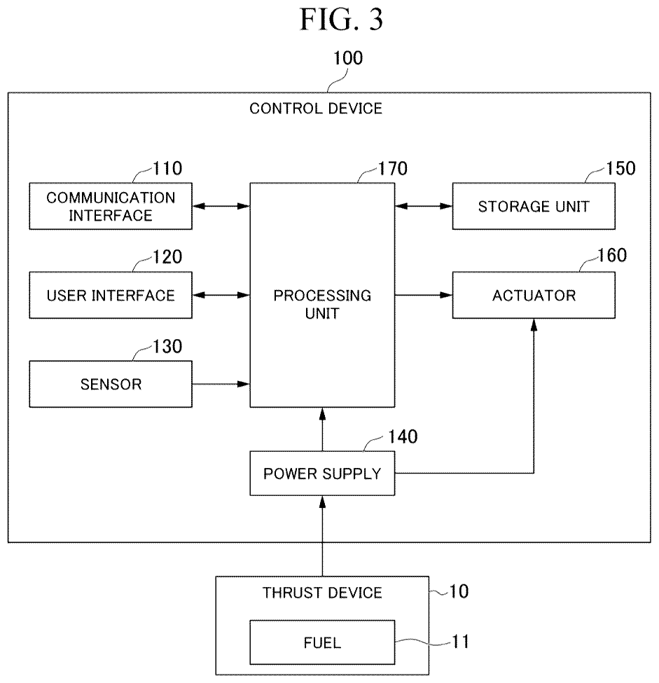

FIG. 3 is a diagram showing an example of a configuration of the control device 100 according to the embodiment. As shown in FIG. 3, the control device 100 includes, for example, a communication interface 110, a user interface 120, a sensor 130, a power supply 140, a storage unit 150, an actuator 160, and a processing unit 170.

The communication interface 110 performs wireless communication with an external device via a network such as, for example, a wide area network (WAN). The external device may be, for example, a remote controller capable of remotely controlling the flight device 1. For example, the communication interface 110 may receive a command from an external device for issuing an instruction for a target attitude and speed to be taken by the flight device 1. Thereby, when the manipulation skill of the user U is immature and independent autonomous flight by the control unit 230 is not possible, an operator skilled in a manipulation from the outside can perform the manipulation.

Moreover, the communication interface 110 may receive information for notifying the user U in flight that the destination B has changed from an external device or may receive information for communicating more detailed information of the destination B to the user U from the external device.

Moreover, the communication interface 110 may transmit information to the external device. For example, the communication interface 110 may transmit detailed information (coordinates, altitude, and the like) about the rescue site to an external device.

The user interface 120 includes an input interface 120a and an output interface 120b. For example, the input interface 120a is a joystick, a handle, a button, a switch, a microphone, and the like. The output interface 120b is, for example, a display, a speaker, or the like. For example, the user U may adjust a thrust force and thrust direction of the thrust device 10 by manipulating a joystick or the like of the input interface 120a or may adjust a shape and direction of the wings 20. Moreover, the user U may adjust the thrust force and thrust direction of the thrust device 10 or adjust the shape and direction of the wing 20 by speaking the speed, altitude, attitude, or the like to be taken by the flight device 1 to a microphone of the input interface 120a.

The sensor 130 is, for example, an inertial measurement device. The inertial measurement device includes, for example, a triaxial acceleration sensor and a triaxial gyro sensor. The inertial measurement device outputs a detection value detected by the triaxial acceleration sensor or the triaxial gyro sensor to the processing unit 170. Detection values from the inertial measurement device include, for example, accelerations and/or angular velocities in horizontal, vertical, and depth directions, a velocity (rate) of each of the pitch, roll, and yaw axes, and the like. The sensor 130 may further include a radar, a finder, a sonar, a Global Positioning System (GPS) receiver, and the like.

The power supply 140 is, for example, a secondary battery such as a lithium-ion battery. The power supply 140 supplies electric power to constituent elements such as the actuator 160 and the processing unit 170. The power supply 140 may further include a solar panel and the like.

Moreover, the actuator 160, the processing unit 170, and the like may use electric power generated by the jet engine of the thrust device 10 in place of or in addition to using the electric power supplied from the power supply 140.

The storage unit 150 is implemented by, for example, a storage device such as a hard disc drive (HDD), a flash memory, an electrically erasable programmable read only memory (EEPROM), a read-only memory (ROM), or a random-access memory (RAM). In the storage unit 150, in addition to various types of programs such as firmware and application programs, a calculation result of the processing unit 170 is stored as a log. Moreover, model information 152 is stored in the storage unit 150. The model information 152, for example, may be installed in the storage unit 150 from an external device via a network or may be installed in the storage unit 150 from a portable storage medium connected to the drive device of the control device 100. The model information 152 will be described below.

The actuator 160 includes, for example, a thrust actuator 162, a sweep actuator 164, and a folding actuator 168.

The thrust actuator 162 drives the thrust device 10 so that a thrust force is given to the flight device 1 or a thrust direction is changed. The sweep actuator 164 rotates the wings 20 about the yaw axis Z_{B}.

The processing unit 170 is implemented by, for example, executing a program stored in the storage unit 150 such as a central processing unit (CPU) or a graphics processing unit (GPU). Moreover, the processing unit 170 may be implemented by hardware such as a large-scale integration (LSI) circuit, an application-specific integrated circuit (ASIC), or a field-programmable gate array (FPGA) or may be implemented by software and hardware in cooperation.

The processing unit 170 controls the thrust actuator 162 on the basis of some or all of (i) an input manipulation of the user U on the input interface 120a, (ii) a detection result of the sensor 130, and (iii) a command for performing a remote manipulation received by the communication interface 110 from an external device. Thereby, the thrust force of the thrust device 10 is controlled and the thrust direction is controlled. For example, the control device 100 controls the thrust actuator 162, such that the thrust force is adjusted by controlling a rotational speed of the duct fan of the jet engine of the thrust device 10 or the thrust direction is adjusted by controlling the thrust vectoring mechanism of the jet engine.

Moreover, when the wings 20 are morphing wings, the control device 100 controls the sweep actuator 164 and the folding actuator 168 on the basis of some or all of (i) to (iii). Thereby, the shape and direction of the wing 20 are controlled. The shape and direction of the wing 20 are examples of a “manipulation quantity of the morphing wing.”

### Processing Flow of Processing Unit

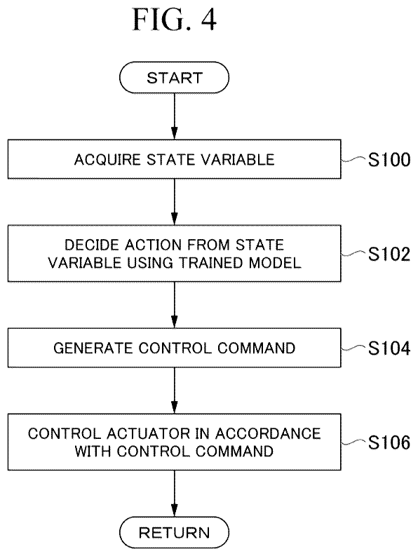

Hereinafter, a flow of a series of processing steps of the processing unit 170 will be described using a flowchart. FIG. 4 is a flowchart of the flow of the series of processing steps of the processing unit 170. The process of the flowchart may be iterated, for example, at predetermined intervals.

First, the processing unit 170 acquires a state variable sₜ indicating a state of an environment surrounding the flight device 1 at current time t (step S100). The state variable sₜ includes, for example, at least one (or preferably all) of the attitude, position, velocity, and angular velocity of the flight device 1 at current time t. For example, the angle included in the state variable sₜ may be an angle about the pitch axis (hereinafter referred to as a pitch angle). Moreover, the angular velocity included in the state variable sₜ may be the angular velocity of the pitch angle. Furthermore, the state variable sₜ may include the thrust force and thrust direction of the thrust device 10 at current time t, and the shape and direction of the wing 20 at current time t. At least one or all of the attitude, position, velocity, and angular velocity at current time t is an example of “state data.” The thrust force and thrust direction of the thrust device 10 at current time t and the shape and direction of the wings 20 at current time t are examples of “manipulation data.”

For example, the processing unit 170 acquires the attitude, position, velocity, and angular velocity from the sensor 130 as the state variable sₜ.

Moreover, when the user U issues an instruction for the thrust force and thrust direction of the thrust device 10 via the input interface 120a, the processing unit 170 may add the input manipulation of the user U on the input interface 120a to the state variable sₜ.

Subsequently, the processing unit 170 reads the model information 152 from the storage unit 150 and decides an optimum action (an action variable) aₜ₊₁ capable of being acquired by the flight device 1 at the next time t+1 from the state variable sₜ using the deep reinforcement learning model MDL defined by the model information 152 (step S102).

The action (the action variable) aₜ₊₁ in the present embodiment is an action for implementing a desired task, for example, the thrust force and thrust direction of the thrust device 10 required to implement the task may be included, and the shape and direction of the wing 20 may be further included. For example, desired tasks may be various tasks for causing the flight device 1 to perform a hovering process while maintaining a certain altitude, smoothly transition from horizontal flight to a hovering position, and fly straight even under strong winds.

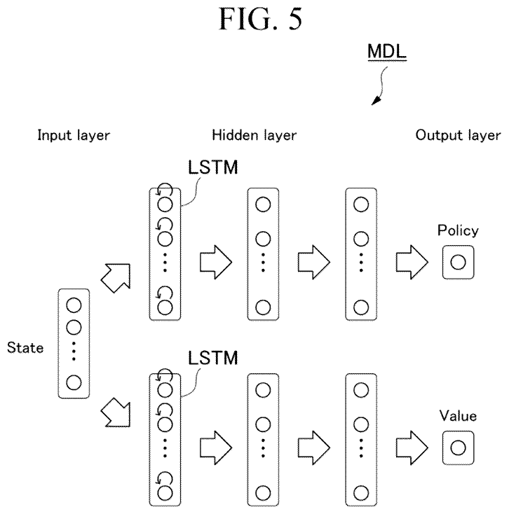

FIG. 5 is a diagram showing an example of a deep reinforcement learning model MDL. The deep reinforcement learning model MDL according to the present embodiment is a neural network using deep reinforcement learning. As shown in FIG. 5, for example, the deep reinforcement learning model MDL may be a recurrent neural network in which a part of an intermediate layer (a hidden layer) is a long short-term memory (LSTM). In the deep reinforcement learning model MDL, dynamics such as weight, center of gravity, and moment of inertia of the flight device 1 and a system response delay are randomly set and learnt using a domain-randomization process.

When learning based on the domain-randomization process (in which the dynamics of the flight device 1 is randomized) is performed, the LSTM of the deep reinforcement learning model MDL stores a time series in which the dynamics of the flight device 1 randomly set is reflected. Thus, the LSTM is provided in the neural network, and therefore learning based on the domain-randomization process is preferably performed.

For example, when the deep reinforcement learning algorithm for training the deep reinforcement learning model MDL is value-based, the deep reinforcement learning model MDL may be trained using a deep Q-network (DQN) or the like. The DQN is a method of training a neural network in a state in which an action value function Q(sₜ, aₜ), which indicates a value when a certain action aₜ is selected at certain time t as a function under a certain environment state sₜ at certain time t, is designated as an approximation function in reinforcement learning referred to as Q-learning. That is, the deep reinforcement learning model MDL trained by the value-based method may be trained to output an action (an action variable) aₜ in which the value (Q value) is maximized among one or more actions (action variables) aₜ capable of being acquired by the flight device 1 at current time t.

In the Q-learning, for example, the weights and biases of the deep reinforcement learning model MDL by increasing a reward when the wing 20 and the thrust device 10 are in an ideal state are learnt. For example, in the sky above a predetermined point, the reward may be increased when the attitude of the flight device 1 is a pitch-up attitude of 90 degrees and the speed of the flight device 1 is a speed that can be regarded as stationary. On the other hand, when the flight device 1 is in contact with the ground or trees or deviates from a predetermined altitude, the reward may be low (for example, zero).

Moreover, for example, when the deep reinforcement learning algorithm for training the deep reinforcement learning model MDL is policy-based, the deep reinforcement learning model MDL may be trained using a policy gradient method (policy gradients) or the like.

Moreover, for example, when the deep reinforcement learning algorithm for training the deep reinforcement learning model MDL is an Actor-Critic algorithm for combining a value and a policy, the critic (evaluator) that evaluates the policy may also be trained at the same time while the actor included in the deep reinforcement learning model MDL is trained. The deep reinforcement learning model MDL illustrated in FIG. 5 is a model trained using an Actor-Critic algorithm such as proximal policy optimization (PPO) and the upper layer is trained to output the policy, and the lower layer is trained to output the value.

The model information 152 for defining such a deep reinforcement learning model MDL includes, for example, coupling information indicating a method in which the units included in each of the plurality of layers constituting the neural network are coupled to each other, various types of information such as coupling coefficients assigned to data input/output between the coupled units, and the like. The coupling information includes, for example, the number of units included in each layer, information for designating a type of unit to which each unit is coupled, an activation function of implementing each unit, and information of a gate provided between the units of the hidden layer and the like. An activation function of implementing the unit may be, for example, a normalized linear function (a rectified linear unit (ReLU) function), a sigmoid function, a step function, another function, or the like. The gate selectively passes or weights data transmitted between units, for example, in accordance with a value (e.g., 1 or 0) returned by the activation function. The coupling coefficient includes, for example, a weight given to the output data when data is output from a unit of a layer to a unit of a deeper layer in a hidden layer of a neural network. The coupling coefficient may include a unique bias component of each layer and the like. Further, the model information 152 may include information for designating the type of activation function of each gate included in the LSTM, a recurrent weight, a peephole weight, and the like.

For example, when at least one of the attitude, position, velocity, and angular velocity of the flight device 1 at current time t and the thrust force and thrust direction of the thrust device 10 at current time t are acquired, the processing unit 170 inputs them to the deep reinforcement learning model MDL as a state variable sₜ. The deep reinforcement learning model MDL to which the state variable sₜ is input outputs the thrust force and thrust direction of the thrust device 10 that are optimal at the next time t+1. As described above, in addition to or in place of the thrust force and thrust direction to be output by the thrust device 10 at the next time t+1, the deep reinforcement learning model MDL may be trained so that the shape or direction to be taken by the wing 20 at the next time t+1 is output.

Returning to the description of the flowchart in FIG. 4, subsequently, the processing unit 170 generates a control command for controlling the actuator 160 of the flight device 1 on the basis of the action (the action variable) aₜ₊₁ to be taken by the flight device 1 decided using the deep reinforcement learning model MDL, i.e., the thrust force and thrust direction to be output by the thrust device 10 at the next time t+1, and the shape and direction to be taken by the wing 20 at the next time t+1 (step S104).

For example, the processing unit 170 may generate a control command of the thrust actuator 162 on the basis of the thrust force and thrust direction of the thrust device 10 output as the action variable aₜ₊₁ by the deep reinforcement learning model MDL. Moreover, the processing unit 170 may generate a control command of the sweep actuator 164 or the folding actuator 168 on the basis of the shape and direction of the wing 20 output as the action variable aₜ₊₁.

Subsequently, the processing unit 170 controls the actuator 160 on the basis of the generated control command (step S106). Thereby, a desired task is implemented, such that the state of the environment surrounding the flight device 1 changes and the state variable indicating the state changes from sₜ to sₜ₊₁.

The processing unit 170 reacquires the state variable sₜ₊₁ at time t+1 as the state variable changes from sₜ to sₜ₊₁. Also, the processing unit 170 continuously gives a control command to the target actuator 160 so that the flight device 1 continuously achieves the desired task in relation to the state variable sₜ₊₁ at time t+1. Thereby, the process of the present flowchart ends.

According to the above-described embodiment, the processing unit 170 of the control device 100 acquires at least one (or preferably all) of the attitude, position, speed, and angular velocity of the flight device 1 at current time t, the thrust force and thrust direction of the thrust device 10 at current time t as the state variable sₜ. At this time, the processing unit 170 may acquire the shape and direction of the wings 20 at current time t as a state variable sₜ in addition to or in place of the thrust force and thrust direction of the thrust device 10 at current time t.

When the state variable sₜ is acquired, the processing unit 170 inputs the state variable sₜ to the deep reinforcement learning model MDL trained in advance by deep reinforcement learning. The processing unit 170 controls the flight device 1 on the basis of the action variable aₜ₊₁ at the next time t+1 output by the deep reinforcement learning model MDL in accordance with an input of the state variable sₜ. Thus, because the flight device 1 is controlled using a deep reinforcement learning model MDL in which deep reinforcement learning has been performed on the basis of the state variable sₜ including the attitude, position, speed, and angular velocity of the flight device 1 at current time t and the thrust force and thrust direction of the thrust device 10 at current time t, the flight device 1 can be appropriately controlled regardless of the physique of the user U even if there is a variation in the physique (a weight, height, or the like) of the user U who wears the flight device 1 in the case of the manned flight. Moreover, even if the user leaves the flight device 1 during the flight and the flight is switched from manned flight to unmanned flight, the flight device 1 can be preferably controlled.

For example, as described above, it is assumed that, when a mountain rescue team wears the flight device 1 and moves to a rescue site (a destination B) within the mountain trail by air, after a first rescue team member arrives at the destination B, the flight device 1 is detached and lands at the destination B, the flight device 1 subsequently returns to the departure point A independently, and a second rescue team member wears the flight device 1 and moves to the rescue site. In this case, for example, if the physique of the first rescue team member and the physique of the second rescue team member are significantly different, it is difficult to use the same flight device 1 with conventional technology. On the other hand, in the present embodiment, in particular, because the recurrent neural network has an LSTM layer, time series storage is possible, and tuning according to the user's physique is possible from a history of control outputs and state variables. As a result, the flight device 1 can continue to fly stably in the same way even if the user U having a heavy weight wears the flight device 1 and even if the user U having a light weight wears the flight device 1.

Moreover, for example, when the first rescue team member arrives at the destination B, subsequently detaches the flight device 1, and lands at the destination B, the load on the flight device 1 decreases rapidly. In this case, it is difficult to keep the flight device 1 stably flying with the conventional technology. On the other hand, in the present embodiment, because deep reinforcement learning is performed in consideration of the dynamics of the flight device 1 and variations in response delay without considering the user's physique, i.e., because deep reinforcement learning is performed using domain-randomization, the flight device 1 can stably continuously fly like when the user U is wearing the flight device 1 even if the user U leaves the flight device 1 and the flight device 1 is alone.

Although modes for carrying out the present invention have been described using embodiments, the present invention is not limited to the embodiments and various modifications and substitutions can also be made without departing from the scope and spirit of the present invention.

### REFERENCE SIGNS LIST

1 Flight device
10 Thrust device
20 Wing
30 Detachable unit
100 Control device
110 Communication interface
120 User interface
130 Sensor
140 Power supply
150 Storage unit
160 Actuator
170 Processing unit

1. A control device for controlling a user-wearable flight device, the control device comprising:
a processing unit configured to
acquire state data related to a state of the flight device and manipulation data related to a manipulation of the flight device,
input the acquired state data and the acquired manipulation data to a model trained using deep reinforcement learning, and
control the flight device on the basis of an output result of the model to which the state data and the manipulation data are input.

2. The control device according to claim 1, wherein the model is a neural network trained by domain randomization.

3. The control device according to claim 1, wherein the model is a recurrent neural network including a memory layer.

4. The control device according to claim 1,
wherein the flight device includes a jet engine,
wherein the state data includes at least one of an attribute, position, speed, and angular velocity of the flight device,
wherein the manipulation data includes a thrust force and a thrust direction of the jet engine, and
wherein the processing unit controls an attribute of the flight device on the basis of the thrust force and the thrust direction output by the model.

5. The control device according to claim 4,
wherein the flight device further includes a morphing wing,
wherein the manipulation data further includes a manipulation quantity of the morphing wing, and
wherein the processing unit controls an attitude of the flight device on the basis of the thrust force, the thrust direction, and the manipulation quantity of the morphing wing output by the model.

6. A control method for controlling a user-wearable flight device, the control method comprising:
acquiring state data related to a state of the flight device and manipulation data related to a manipulation of the flight device,
inputting the acquired state data and the acquired manipulation data to a model trained using deep reinforcement learning, and
controlling the flight device on the basis of an output result of the model to which the state data and the manipulation data are input.

7. A non-transitory computer-readable storage medium storing a program for causing a computer, which controls a user-wearable flight device, to:
acquire state data related to a state of the flight device and manipulation data related to a manipulation of the flight device,
input the acquired state data and the acquired manipulation data to a model trained using deep reinforcement learning, and
control the flight device on the basis of an output result of the model to which the state data and the manipulation data are input.
